(19) United States
(12) Patent Application Publication
(10) Pub. No.: US 2010/0049865 A1
(43) Pub. Date: Feb. 25, 2010

(54) Decoding Order Recovery in Session Multiplexing

(75) Inventors: Miska Matias Hannuksela, Ruutana (FI); Ye-Kui Wang, Bridgewater, NJ (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/424,788

(22) Filed: Apr. 16, 2009

Related U.S. Application Data
(60) Provisional application No. 61/045,539, filed on Apr. 16, 2008.
(60) Provisional application No. 61/061,975, filed on Jun. 16, 2008.

(51) Int. Cl. G06F 15/16

(52) U.S. Cl. 709/231; 709/233; 709/227

(57) ABSTRACT

Systems and methods are provided for signaling the decoding order of ADUs to enable efficient recovery of the decoding order of ADUs when session multiplexing is in use. A decoding order recovery process in a receiver is improved when session multiplexing is in use. For example, various embodiments improve the decoding order recovery process of SVC when no CS-DONs are utilized. First information associated with a first media sample to identify a second media sample is signaled upon packetization to indicate/aid in recovering. Upon de-packetizing, a decoding order of the first media sample and the second media sample is determined based on the received signaling of the first information.

### RELATED APPLICATIONS

This application claims priority to U.S. Application No. 61/045,539 filed Apr. 16, 2008 and U.S. Application No. 61/061,975 filed Jun. 16, 2008, which are incorporated herein by reference.

### FIELD OF THE INVENTION

Various embodiments relate to transmission and reception of coded media data in a packet-based network environment. More specifically, various embodiments relate to the signaling of the decoding order of application data units (ADUs) to enable efficient recovery of the decoding order of ADUs when session multiplexing is in use. In session multiplexing, different subsets of the ADUs are carried in different transmission sessions.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The Real-time Transport Protocol (RTP) (described in H. Schulzrinne, S. Casner, S., R. Frederick, and V. Jacobson, “RTP: A Transport Protocol for Real-Time Applications”, IETF STD 64, RFC 3550, July 2003, and available at http://www.ietf.org/rfc/rfc3550.txt) is used for transmitting continuous media data, such as coded audio and video streams in networks based on the Internet Protocol (IP). The Real-time Transport Control Protocol (RTCP) is a companion of RTP, i.e., RTCP should be used to complement RTP when the network and application infrastructure allow. RTP and RTCP are generally conveyed over the User Datagram Protocol (UDP), which in turn, is conveyed over the Internet Protocol (IP). There are two versions of IP, namely IPv4 and IPv6, which differ, among other things, as to the number of addressable endpoints. RTCP is used to monitor the quality of service provided by the network and to convey information about the participants in an on-going session. RTP and RTCP are designed for sessions that range from one-to-one communication to large multicast groups of thousands of endpoints. In order to control the total bitrate caused by RTCP packets in a multiparty session, the transmission interval of RTCP packets transmitted by a single endpoint is proportional to the number of participants in the session. Each media coding format has a specific RTP payload format, which specifies how media data is structured in the payload of an RTP packet.

RTP also allows for synchronization between packets of different RTP sessions, by utilizing RTP timestamps that are included in the RTP header. The RTP timestamps are used to determine audio and video access unit presentation times. Synchronizing content transported in RTP packets is described in RFC 3550. That is, RTP timestamps convey the sampling instant of access units at an encoder, where an RTP timestamp may be expressed in units of a clock, which increases monotonically and linearly, and the frequency of which is specified (explicitly or by default) for each payload format. Such a clock may be utilized as the sampling clock.

RTCP utilizes a plurality of different packet types, one being a RTCP Sender Report (SR) packet type. THE RTCP SR packet type contains an RTP timestamp and an NTP (Network Time Protocol) timestamp, both of which correspond to the same instant in time. While the RTP timestamp is expressed in the same units as RTP timestamps in data packets, “wall-clock” time is used for expressing the NTP timestamp. Receivers can achieve synchronization between RTP sessions by using the correspondence between the RTP and NTP timestamps if the same wall-clock is used for all RTCP streams. Receipt of a RTCP SR packet relating to the audio stream and an RTCP SR packet relating to the video stream is needed for the synchronization of an audio and video stream. The RTCP SR packets provide a pair of NTP timestamps along with corresponding RTP timestamps that are used to align the media. It should be noted that the time between sending subsequent RTCP SR packets may vary. That is, upon entering a streaming session there may be an initial delay due to the receiver not yet having the necessary information to perform inter-stream synchronization.

Signaling refers to the information exchange concerning the establishment and control of a connection and the management of the network, in contrast to user-plane information transfer, such as real-time media transfer. In-band signaling refers to the exchange of signaling information within the same channel or connection that user-plane information, such as real-time media, uses. Out-of-band signaling is done on a channel or connection that is separate from the channels used for the user-plane information, such as real-time media.

In unicast, multicast, and broadcast streaming applications, the available streams are announced and their coding formats are characterized to enable each receiver to conclude if it can decode and render the content successfully. Sometimes, a number of different format options for the same content are provided, from which each receiver can choose the most suitable one for its capabilities and/or end-user wishes. The available media streams are often described with the corresponding media type and its parameters that are included in a session description formatted according to the Session Description Protocol (SDP). In unicast streaming, applications the session description is usually carried by the Real-Time Streaming Protocol (RTSP), which is used to set up and control the streaming session. In broadcast and multicast streaming applications, the session description may be carried as part of the electronic service guide (ESG) for the service.

In video conferencing applications, the codecs which are utilized and their modes are negotiated during a session setup, e.g., with the Session Initiation Protocol (SIP). Among other things, SIP conveys messages according to the SDP offer/answer model. An offer/answer negotiation begins with an initial offer generated by one of the endpoints referred to as the offerer, and including an SDP description. Another endpoint, an answerer, responds to the initial offer with an answer that also includes an SDP description. Both the offer and the answer include a direction attribute indicating whether the endpoint desires to receive media, send media, or both. The semantics included for the media type parameters may depend on a direction attribute. In general, there are two categories of media type parameters. First, capability parameters describe the limits of the stream that the sender is capable of producing or the receiver is capable of consuming, when the direction attribute indicates reception only or when the direction attribute includes sending, respectively. Certain capability parameters, such as the level specified in many video coding formats, may have an implicit order in their values that allows the sender to downgrade the parameter value to a minimum that all recipients can accept. Second, certain media type parameters are used to indicate the properties of the stream that are going to be sent. As the SDP offer/answer mechanism does not provide a way to negotiate stream properties, it is advisable to include multiple options of stream properties in the session description or conclude the receiver acceptance for the stream properties in advance.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also know as ISO/IEC MPEG-4 AVC). The scalable extension to H.264/AVC (i.e., H.264/AVC Amendment 3) is known as the scalable video coding (SVC) standard. In addition, there are currently efforts underway with regards to the development of new video coding standards. One standard under development is the multi-view coding (MVC) standard, which is also an extension of H.264/AVC. Another standardization effort involves the development of China video coding standards.

The published SVC standard is available through ITU-T or ISO/IEC, and a draft of the SVC standard, the Joint Draft 8.0, is freely available in JVT-X201, “Joint Draft ITU-T Rec. H.264/ISO/IEC 14496-10/Amd.3 Scalable video coding”, (available at http://ftp3.itu.ch/av-arch/jvt-site/2007_06_Geneva/JVT-X201.zip). A recent draft of MVC is available in JVT-Z209, “Joint Draft 6.0 on Multiview Video Coding”, 25th JVT meeting, Antalya, Turkey, January 2008, (available at http://ftp3.itu.ch/av-arch/jvt-site/2008_{—}01_Antalya/JVT-Z209.zip).

In layered coding arrangements, one can commonly observe a hierarchy of layers. For a given higher layer, there is typically at least one lower layer upon which that higher layer depends. When data from the lower layer is lost, the data of the higher layer becomes much less meaningful, and completely useless in some circumstances. Therefore, if there is a need to discard layers or packets belonging to certain layers, it makes sense to first discard the higher layers or packets belonging to the higher layers or, at a minimum, to perform such discarding before discarding lower layers or packets belonging to lower layers.

This layered coding concept can also be extended to MVC, where each view can be considered as a layer, in particular within the transport mechanism, and each view can be represented by multiple scalable layers. In MVC, video sequences output from different cameras, each corresponding to a view, are encoded into one bitstream. After decoding, to display a certain view, the decoded pictures belonging to that view are displayed.

Layered multicast is a transport technique for scalable coded bitstreams, e.g., SVC or MVC bitstreams. A commonly employed technology for the transport of media over Internet Protocol (IP) networks is known as Real-time Transport Protocol (RTP). In layered multicast using RTP, a layer or a subset of the layers of a scalable bitstream is transported in its own RTP session, where each RTP session belongs to a multicast group. Receivers can join or subscribe to desired RTP sessions or multicast groups to receive the bitstream of certain layers. Conventional RTP and layered multicast is described, e.g., in H. Schulzrinne, S. Casner, S., R. Frederick, and V. Jacobson, “RTP: A Transport Protocol for Real-Time Applications”, IETF STD 64, RFC 3550, July 2003, available from http://www.ietf.org/rfc/rfc3550.txt and S. McCanne, V. Jacobson, and M. Vetterli, “Receiver-driven layered multicast” in Proc. of ACM SIGCOMM'96, pp. 117-130, Stanford, CA, August 1996. Additionally, layered multicast is a typical use case of session multiplexing. In the context of transporting scalable bitstreams using RTP, session multiplexing refers to a mechanism wherein the scalable bitstream or a subset thereof is transported in more than one RTP session.

An encoded bitstream according to H.264/AVC or its extensions, e.g. SVC, is either a network abstraction layer (NAL) unit stream, or a byte stream formed by prefixing a start code to each NAL unit in a NAL unit stream. A NAL unit stream is simply a concatenation of a number of NAL units. A NAL unit is comprised of a NAL unit header and a NAL unit payload. The NAL unit header contains, among other items, the NAL unit type. The NAL unit type indicates whether the NAL unit contains a coded slice, a data partition of a coded slice, or other data not containing coded slice data, e.g., a parameter set and supplemental enhancement information (SEI) messages, a sequence or picture parameter set, and so on. An access unit (AU) consists of all NAL units pertaining to one presentation time. An AU is also referred to as a media sample. The video coding layer (VCL) contains the signal processing functionality of the codec; mechanisms such as transform, quantization, motion-compensated prediction, loop filter, inter-layer prediction. A coded picture of a base or enhancement layer consists of one or more slices. The NAL encapsulates each slice generated by the video coding layer (VCL) into one or more NAL units. A NAL unit is an example of an application data unit (ADU), which is an elementary unit for the application layer in the protocol stack model. Media codecs are considered to reside in the application layer. It is usually beneficial to have a process that utilizes complete and error-free ADUs in the application layer, although methods of handling incomplete or erroneous ADUs may be possible.

The scalability structure in SVC is characterized by three syntax elements: temporal_id, dependency_id and quality_id. The syntax element temporal_id is used to indicate the temporal scalability hierarchy or, indirectly, the frame rate. A bitstream subset comprising access units of a smaller maximum temporal_id value has a smaller frame rate than a bitstream subset (of the same bitstream) comprising access units of a greater maximum temporal_id. A given temporal layer typically depends on the lower temporal layers (i.e., the temporal layers with smaller temporal_id values) but does not depend on any higher temporal layer. The syntax element dependency_id is used to indicate the coarse granular scalability (CGS) inter-layer coding dependency hierarchy (which, as described earlier, includes both signal-to-noise ratio and spatial scalability). Within an access unit, VCL NAL units of a smaller dependency_id value may be used for inter-layer prediction for VCL NAL units with a greater dependency_id value. The syntax element quality_id is used to indicate the quality level hierarchy of a medium grain scalability (MGS) layer. Within any access unit and with an identical dependency_id value, VCL NAL units with quality_id equal to QL use VCL NAL units with quality_id equal to QL-1 for inter-layer prediction. The NAL units in one access unit having an identical value of dependency_id are referred to as a dependency representation. Within one dependency unit, all of the data units having an identical value of quality_id are referred to as a layer representation.

The H.264/AVC RTP payload format is specified in RFC 3984, available from http://www.ietf.org/rfc/rfc3984.txt. RFC 3984 specifies three packetization modes: single NAL unit packetization mode; non-interleaved packetization mode; and interleaved packetization mode. In the interleaved packetization mode, each NAL unit included in a packet is associated with a decoding order number (DON)-related field such that the NAL unit decoding order can be derived. No DON-related fields are available when the single NAL unit packetization mode or the non-interleaved packetization mode is used.

A recent draft of the SVC RTP payload format is available from http://www.ietf.org/internet-drafts/draft-ietf-avt-rtp-svc-10.txt at the time of writing this patent application. In this recent draft, a payload content scalability information (PACSI) NAL unit is specified to contain scalability information, among other types of information, for NAL units included in the RTP packet containing the PACSI NAL unit.

Scalable real-time media can be transmitted in more than one transmission session. For example, the base layer of an SVC bitstream can be transmitted in its own transmission session, while the remaining NAL units of the SVC bitstream can be transmitted in another transmission session. The transmission sessions may not be synchronized in terms of packet order, e.g., data may not be sent in the order it appears in the scalable bitstream. Packets may also become reordered unintentionally on the transmission path, e.g., due to different transmission routes. A media decoder expects a single bitstream where the data units appear in a specified order. Hence, the decoding order of scalable media transmitted over several transmission sessions must be recovered in receivers. That is, a receiver receiving more than one RTP transmission session feeds the NAL units conveyed in all of the transmission sessions in “decoding order” to a decoder. In many coding standards, including H.264/AVC, SVC, and MVC, the decoding order is unambiguously specified. Generally, there may be multiple valid decoding orders for a stream of ADUs, each meeting the constraints of the decoding algorithm and bitstream specification.

As long as a media sample (usually a coded frame) is represented by data units present in each and every transmission session, the decoding order recovery can be performed with the knowledge of layer dependencies between sessions. That is, the decoding order recovery process can reorder the received NAL units as opposed to some reception order (e.g., after de-jittering) to a proper decoding order. However, when a media sample is not represented by data units present in each and every transmission session, the decoding order recovery process becomes unclear without additional information given by the sender. A media sample may not be represented in each transmission session, when packet losses have occurred or when temporal scalability has been applied (e.g., a base layer provides a stream with 15 frames per second and the enhancement layer doubles the frame rate, or one view provides a stream with 15 frames per second and another view of the same multiview bitstream provides a stream with 30 frames per second).

For example, FIG. 1 is an exemplary scenario showing an order of received NAL units. In order to achieve proper decoding, it must be ensured that the order of the received NAL units are sent to the decoder as, e.g., 0 1 2 3 4 5 6 7 . . . (as denoted by the cross-session DON (CS-DON). It should be noted that CS-DON and cross-layer DON (CL-DON) are used interchangeably. Additionally, in-session DON (IS-DON) is shown as being the same for both sessions 0 and 1 as is a presentation time stamp (PTS) (that is equal to a network time protocol (NTP) timestamp), which can be utilized to identify AUs. FIG. 1 illustrates NAL units NALu_0_0 denoted by CS-DON value 0, NALu_0_1 denoted by CS-DON value 1, NALu_0_2 denoted by CS-DON value 4 . . . as being transmitted in a session 0. NALu_1_0 denoted by CS-DON value 2, NALu_1_1 denoted by CS-Don value 3, NALu_1_2 denoted by CS-Don value 5 . . . are shown as being transmitted in a session 1. Additionally, FIG. 1 illustrates that NALu_1_0 and NALu_1_1 can make up an AU_0, an NALu_1_2 makes up AU_1 and so on. Again, because the NAL units are transmitted in multiple sessions, e.g., session 0 and session 1, in order to properly decode the NAL units, the CS-DON values of the NAL units must be determined as the CS-DON values are indicative of the decoding order.

Additionally, scenarios can occur where the PTS/NTP timestamp order is different than the decoding order. For example, FIG. 2 illustrates such a scenario where AU_1 has a PTS of 2 and AU_2 has a PTS of 1. Hence, RTP timestamps (even if initially set to be equivalent for different sessions) do not necessarily indicate the decoding order. Further still, scenarios may occur where the CS-DON values of the NAL units for a particular access unit and RTP session are interleaved with those for the same access unit but another RTP session. In other words, the value of CS-DON may not be a non-decreasing function of the dependency order of RTP sessions. For example, FIG. 3 illustrates a scenario where, NALu_1_0 (as an SEI NAL unit only pertaining to session 1) may have a CS-DON value of 1 as opposed to 2 (as shown in FIGS. 1 and 2), and NALu_0_1 (as a parameter set NAL unit pertaining only to session 1) may have a CS-DON value of 2 instead of 1 (as shown in FIGS. 1 and 2). Here, the order of received NAL units may still be, e.g., NALu_0_0, NALu_0_1, NALu_1_0, NALu_1_1, . . . , which, if sent to the decoder at that order, would result in an incorrect ordering of NAL units. In this example, a decoding order recovery process that assumed NAL units of an AU to be ordered in their layer dependency order would similarly result into an incorrect ordering of NAL units.

Furthermore, a scenario can occur where there are two AUs (A and B) for which all RTP sessions contain NAL units and at least two AUs (C and D) that are between AUs A and B in decoding. If no RTP session containing data for AU C contains data for AU D, the mutual decoding order of AUs C and D cannot be determined without indications to determine CS-DON. Such a situation may occur when there are packet losses or two sessions convey temporal scalable layers. To be more detailed, packet losses may result in some PTS values being present in one RTP session while not present in another RTP session. When two sessions convey two temporal scalable layers without packet losses, the PTS values of the sessions typically differ. For example, FIG. 4 illustrates that, e.g., NALu_1_2 of AU_1 and NALu_0_3 of AU_2 are lost. In this example, the respective decoding order of AU_1 and AU_2 cannot be reliably concluded based on IS-DON, because sequences of IS-DON values are allowed to have gaps, and it can therefore be concluded only that both AU_1 and AU_2 follow AU_0 in decoding order but it cannot be concluded in which order they follow AU_0.

Non-AU-aligned NAL units are defined as those NAL units that exist in one session but there are no NAL units with the same NTP timestamp in another session. Other NAL units are referred to as AU-aligned NAL units. For example, FIG. 5 illustrates a scenario containing only non-AU-aligned NAL units, where AU_0 only has NALu_0_0 in session 0 and no NAL units in session 1, AU_1 has NALu_1_0 in session 1 but no NAL units in session 0. FIG. 5 further illustrates that AU_2 has NALu_0_1 in session 0 and no NAL units in session 1, while AU_3 is shown as having NALu_1_2 in session 1 and no NAL units in session 0. The respective decoding order of NAL units in different sessions cannot be concluded based on IS-DON. Furthermore, type I non-AU-aligned NAL units are defined as those NAL units that exists in a lower session (session 0) but there are no NAL units with the same NTP timestamp in a higher session (session 1). Type II non-AU-aligned NAL units refer to those NAL units that exists in a higher session (session 1) but there are no NAL units with the same NTP timestamp in a lower session (session 0).

Conventional solutions to the above-described scenarios have various constraints. For example and with regard to “classical RTP decoding order recovery mode” (described in the recent draft of the SVC RTP payload format available from http://www.ietf.org/internet-drafts/draft-ietf-avt-rtp-svc-10.txt), in scenarios where packets are lost, an RTP receiver must discard some received NAL units (e.g., those that neighbor the lost NAL units). Additionally, an RTP sender must support generation and insertion of NAL units to avoid, e.g., type I non-AU-aligned NAL units, and receivers must potentially understand the inserted NAL units to be able to remove them from the bitstream passed to the decoder. Such additional NAL units may make a received bitstream non-conforming to the SVC coding specification because of conflicts in buffering—hence, they should be removed from the bitstream passed to the decoder. Delays can also become an issue.

The multimedia container file format is an important element in the chain of multimedia content production, manipulation, transmission and consumption. There are substantial differences between the coding format (a.k.a. elementary stream format) and the container file format. The coding format relates to the action of a specific coding algorithm that codes the content information into a bitstream. The container file format comprises means of organizing the generated bitstream in such way that it can be accessed for local decoding and playback, transferred as a file, or streamed, all utilizing a variety of storage and transport architectures. Furthermore, the file format can facilitate interchange and editing of the media as well as recording of received real-time streams to a file.

Available media file format standards include ISO base media file format (ISO/IEC 14496-12), MPEG-4 file format (ISO/IEC 14496-14, also known as the MP4 format), AVC file format (ISO/IEC 14496-15) and 3GPP file format (3GPP TS 26.244, also known as the 3GP format). Other formats are also currently in development.

The Digital Video Broadcasting (DVB) organization is currently in the process of specifying the DVB File Format, a draft of which is available in DVB document TM-FF0020r8. The primary purpose of defining the DVB File Format is to ease content interoperability between implementations of DVB technologies, such as set-top boxes according to current (DVT-T, DVB-C, DVB-S) and future DVB standards, IP television receivers, and mobile television receivers according to DVB-H and its future evolutions. The DVB File Format will allow exchange of recorded (read-only) media between devices from different manufacturers, exchange of content using USB mass memories or similar read/write devices, and shared access to common disk storage on a home network, as well as much other functionality.

The ISO file format is the basis for most current multimedia container file formats, generally referred to as the ISO family of file formats. The ISO base media file format is the basis for the development of the DVB File Format as well.

Referring now to FIG. 6, a simplified structure of the basic building block 600 in the ISO base media file format, generally referred to as a “box”, is illustrated. Each box 600 has a header and a payload. The box header indicates the type of the box and the size of the box in terms of bytes. Many of the specified boxes are derived from the “full box” (FullBox) structure, which includes a version number and flags in the header. A box may enclose other boxes, such as boxes 610 and 620, described below in further detail. The ISO file format specifies which box types are allowed within a box of a certain type. Furthermore, some boxes are mandatory to be present in each file, while others are optional. Moreover, for some box types, more than one box may be present in a file. In this regard, the ISO base media file format specifies a hierarchical structure of boxes.

According to the ISO family of file formats, a file consists of media data and metadata that are enclosed in separate boxes, the media data (mdat) box 620 and the movie (moov) box 610, respectively. The movie box may contain one or more tracks, and each track resides in one track box 612, 614. A track can be one of the following types: media, hint or timed metadata. A media track refers to samples formatted according to a media compression format (and its encapsulation to the ISO base media file format). A hint track refers to hint samples, containing cookbook instructions for constructing packets for transmission over an indicated communication protocol. The cookbook instructions may contain guidance for packet header construction and include packet payload construction. In the packet payload construction, data residing in other tracks or items may be referenced (e.g., a reference may indicate which piece of data in a particular track or item is instructed to be copied into a packet during the packet construction process). A timed metadata track refers to samples describing referred media and/or hint samples. For the presentation one media type, typically one media track is selected.

The ISO base media file format does not limit a presentation to be contained in one file, and it may be contained in several files. One file contains the metadata for the whole presentation. This file may also contain all the media data, whereupon the presentation is self-contained. The other files, if used, are not required to be formatted to ISO base media file format, are used to contain media data, and may also contain unused media data, or other information. The ISO base media file format concerns the structure of the presentation file only. The format of the media-data files is constrained the ISO base media file format or its derivative formats only in that the media-data in the media files must be formatted as specified in the ISO base media file format or its derivative formats.

A key feature of the DVB file format is known as reception hint tracks, which may be used when one or more packet streams of data are recorded according to the DVB file format. Reception hint tracks indicate the order, reception timing, and contents of the received packets among other things. Players for the DVB file format may re-create the packet stream that was received based on the reception hint tracks and process the re-created packet stream as if it was newly received. Reception hint tracks have an identical structure compared to hint tracks for servers, as specified in the ISO base media file format. For example, reception hint tracks may be linked to the elementary stream tracks (i.e., media tracks) they carry by track references of type ‘hint’. Each protocol for conveying media streams has its own reception hint sample format.

Servers using reception hint tracks as hints for the sending of the received streams should handle the potential degradations of the received streams, such as transmission delay jitter and packet losses, gracefully and ensure that the constraints of the protocols and contained data formats are obeyed regardless of the potential degradations of the received streams.

The sample formats of reception hint tracks may enable constructing of packets by pulling data out of other tracks by reference. These other tracks may be hint tracks or media tracks. The exact form of these pointers is defined by the sample format for the protocol, but in general they consist of four pieces of information: a track reference index, a sample number, an offset, and a length. Some of these may be implicit for a particular protocol. These ‘pointers’ always point to the actual source of the data. If a hint track is built ‘on top’ of another hint track, then the second hint track must have direct references to the media track(s) used by the first where data from those media tracks is placed in the stream.

Conversion of received streams to media tracks allows existing players compliant with the ISO base media file format to process DVB files as long as the media formats are also supported. However, most media coding standards only specify the decoding of error-free streams, and consequently it should be ensured that the content in media tracks can be correctly decoded. Players for the DVB file format may utilize reception hint tracks for handling of degradations caused by the transmission, i.e., content that may not be correctly decoded is located only within reception hint tracks. The need for having a duplicate of the correct media samples in both a media track and a reception hint track can be avoided by including data from the media track by reference into the reception hint track.

Currently, five types of reception hint tracks are being specified: MPEG-2 transport stream (MPEG2-TS), Real-Time Transport Protocol (RTP), protected MPEG2-TS, protected RTP, and Real-Time Transport Control Protocol (RTCP) reception hint tracks. Samples of an MPEG2-TS reception hint track contain MPEG2-TS packets or instructions to compose MPEG2-TS packets from references to media tracks. An MPEG-2 transport stream is a multiplex of audio and video program elementary streams and some metadata information. It may also contain several audiovisual programs. An RTP reception hint track represents one RTP stream, typically a single media type. Protected MPEG2-TS and protected RTP hint tracks represent packets that are at least partly covered by a content protection scheme. The content protection scheme may include content encryption. The sample format of the protected reception hint tracks is identical compared to that of the respective (non-protected) reception hint track. The sample description of the protection hint tracks contains additionally information on the protection scheme. An RTCP reception hint track may be associated with an RTP reception hint track and represents the RTCP packets received for the associated RTP stream.

MPEG2-TS, RTP, and RTCP reception hint tracks were also accepted into the Technologies under Consideration for the ISO Base Media File Format (ISO/IEC MPEG document N9680).

### SUMMARY OF THE INVENTION

Various embodiments provide systems and methods of signaling the decoding order of ADUs to enable efficient recovery of the decoding order of ADUs when session multiplexing is in use. A decoding order recovery process in a receiver is improved when session multiplexing is in use. For example, various embodiments improve the decoding order recovery process of SVC when no CS-DONs are utilized.

In accordance with one embodiment, systems and methods of packetizing a media stream into transport packets are provided. It is determined whether application data units are to be conveyed in a first transmission session and a second transmission session. Upon a determination that the application data units are to be conveyed in the first transmission session and the second transmission session, at least a part of a first media sample in a first packet and at least a part of a second media sample in a second packet are packetized, where the first media sample and the second media sample having a determined decoding order. Additionally, signaling first information to identify the second media sample, where the first information is associated with the first media sample, is performed, and where the first information can be, e.g., a first interval between the first media sample and the second media sample.

In accordance with another embodiment, systems and methods of de-packetizing transport packets of a first transmission session and a second transmission session into a media stream are provided. Media data included in the first transmission session is required to decode media data included in the second transmission session. A first packet is de-packetized, where the first packet includes at least a part of a first media sample. Additionally, a second packet including at least a part of a second media sample is de-packetized. A decoding order of the first media sample and the second media sample is determined based on received signaling of first information to identify the second media sample, where the first information is associated with the first media sample, and the first information can be, e.g., a first interval between the first media sample and the second media sample.

These and other advantages and features of various embodiments of the present invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of the invention are described by referring to the attached drawings, in which:

FIG. 1 is a graphical representation of an exemplary decoding order recovery scenario;

FIG. 2 is a graphical representation of an exemplary decoding order recovery scenario where a PTS/NTP timestamp order is different than a decoding order;

FIG. 3 is a graphical representation of an exemplary decoding order recovery scenario where a decoding order recovery process would result in an incorrect ordering of NAL units

FIG. 4 is a graphical representation of an exemplary decoding order recovery scenario where a respective decoding order of AUs cannot be reliably concluded based on IS-DON values that are allowed to have gaps;

FIG. 5 is a graphical representation of an exemplary decoding order recovery scenario where a decoding order of NAL units in different sessions cannot be concluded based on IS-DON;

FIG. 6, a structure of a basic building block in the ISO base media file format;

FIG. 7 is a graphical representation of a modified PACSI NAL unit structure in accordance with various embodiments;

FIG. 8 is a flow chart illustrating exemplary processes performed by a receiver in conjunction with various embodiments;

FIG. 9 is a graphical representation of an exemplary session multiplexing scenario with different jitters between sessions at startup;

FIG. 10 is a graphical representation of another exemplary session multiplexing scenario (with no jitter between sessions);

FIG. 11 is a flow chart illustrating processes performed in accordance with packetizing a media stream into packets in accordance with various embodiments;

FIG. 12 is a flow chart illustrating processes performed in accordance with de-packetizing transmission/transport packets in accordance with various embodiments;

FIG. 13 is a graphical representation of a generic multimedia communication system within which various embodiments may be implemented;

FIG. 14 is a perspective view of an electronic device that can be used in conjunction with the implementation of various embodiments of the present invention; and

FIG. 15 is a schematic representation of the circuitry which may be included in the electronic device of FIG. 14.

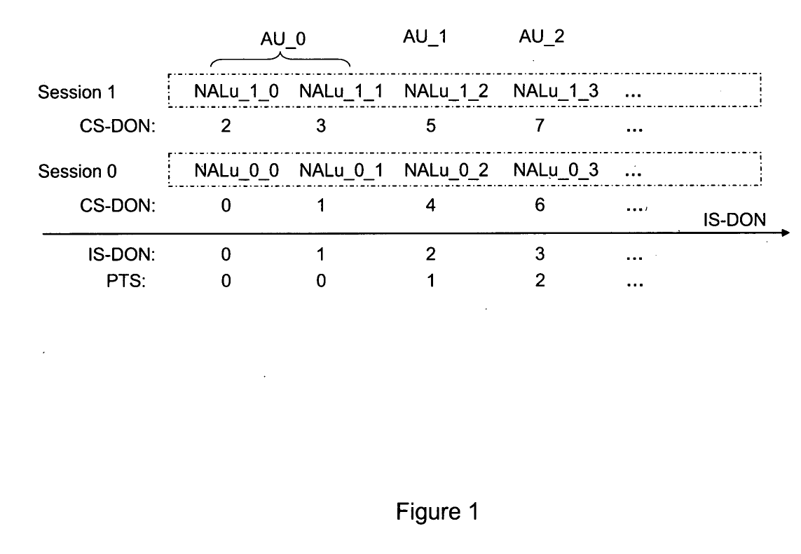

### DETAILED DESCRIPTION OF THE PREFERRED EMBODIMENTS

Various embodiments provide systems and methods of signaling the decoding order of ADUs to enable efficient recovery of the decoding order of ADUs when session multiplexing is in use. A decoding order recovery process in a receiver is improved when session multiplexing is in use. For example, various embodiments improve the decoding order recovery process of SVC when no CS-DONs are utilized. As described above, session multiplexing involves, e.g., different subsets of the ADUs being carried in different transmission/transport sessions. It should be noted that although various embodiments herein are described in the context of SVC using RTP, various embodiments are applicable to any layered and/or scalable codec using any other transport protocol as long as a session multiplexing mechanism is in use.

According to various embodiments, a next media sample in a decoding order, or alternatively, an interval between media samples, in any transmission session is indicated to a receiver(s). The indication may, for example, be effectuated by including an RTP timestamp difference (e.g., between a next media sample in the decoding order and a current media sample carried in a present packet) in the present packet. Based on such an indication, the receiver(s) can recover the decoding order across multiple transmission sessions even if no NAL units were present for some AUs in some transmission sessions of the multiple transmission sessions. Additionally, various embodiments can be implemented as, e.g., a replacement for the current decoding order recovery processes of the SVC RTP payload specification draft.

In accordance with one embodiment, cross-session decoding order sequence (CS-DOS) information enables a receiver(s) to recover the decoding order of NAL units across multiple RTP sessions. The CS-DOS information must be present in session description protocol (SDP) or included in PACSI NAL units. If the CS-DOS information is present in both SDP and PACSI NAL units, the CS-DOS information must be semantically identical in both.

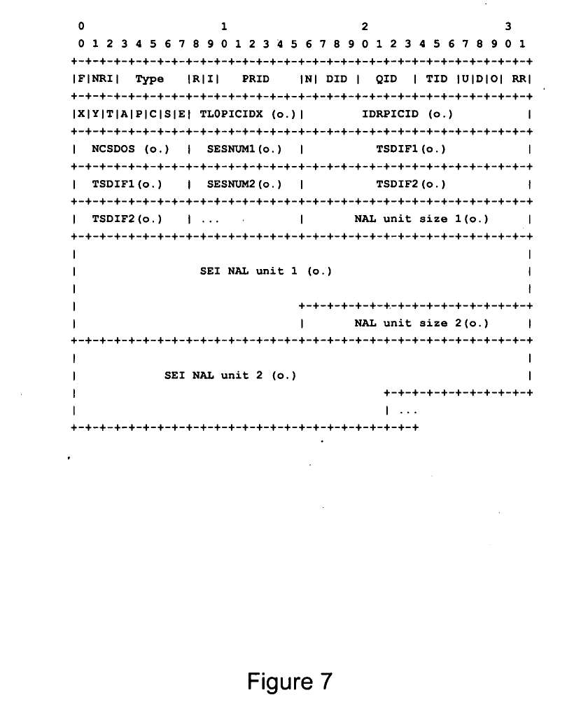

FIG. 7 is a graphical representation of a modified PACSI NAL unit structure, where the PACSI NAL unit may be present in a single NAL unit packet, as when utilizing, e.g., the single NAL unit packetization mode or when the single NAL unit packet containing the PACSI NAL unit precedes a Fragmentation Unit A (FU-A) packet in transmission order within an RTP session. In FIG. 7, fields suffixed by “(o.)” are optional, and “ . . . ” indicates a repetition of the previous field or fields (as indicated by semantics).

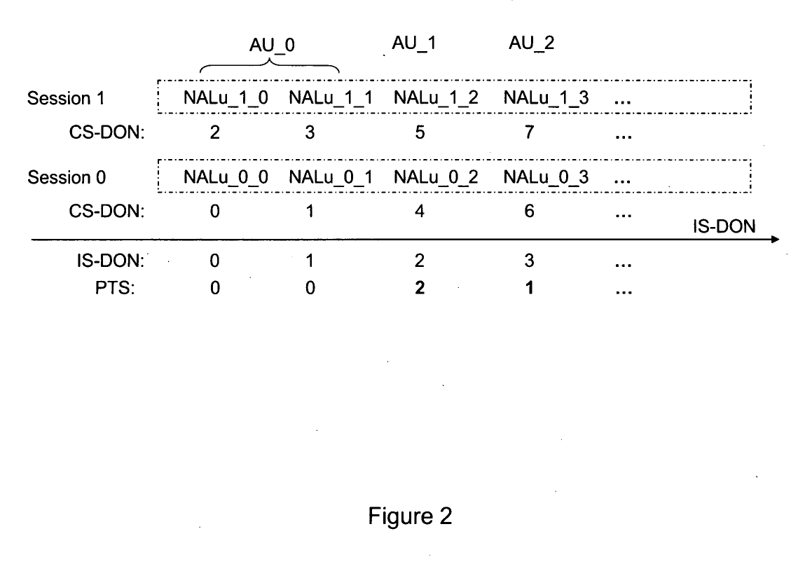

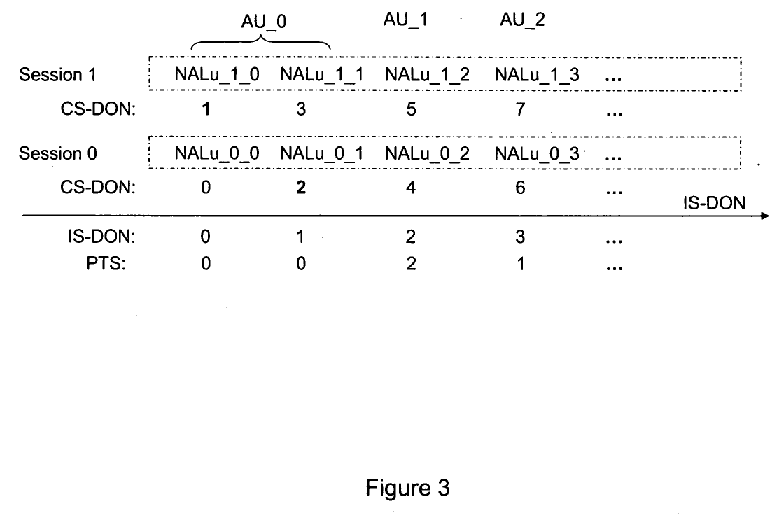

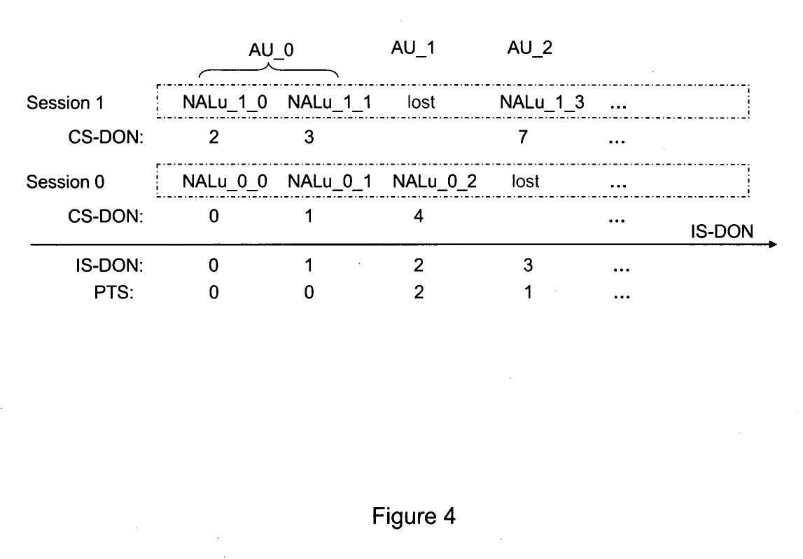

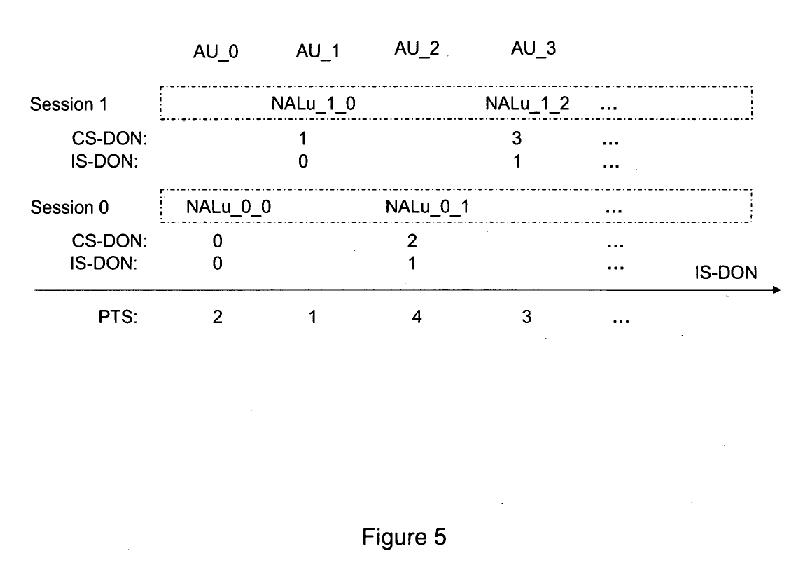

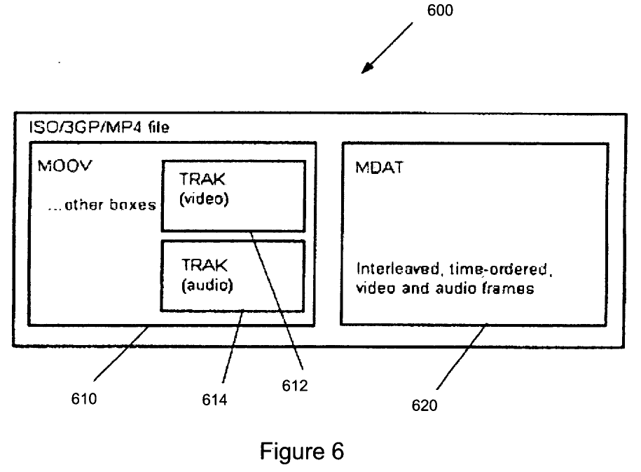

As shown in FIG. 7, the first four octets 0, 1, 2, and 3, are the same as the first four octets which comprise a conventional four-byte SVC NAL unit header. They are followed by one always-present octet, a pair of TL0PICIDX and IDCPICID fields, which is optionally present, NCSDOS field and SESNUM and TSDIF pairs (optionally present), as well as zero or more SEI NAL units, each preceded by a 16-bit unsigned size field (in network byte order) that indicates the size of the following NAL unit in bytes (excluding these two octets, but including the NAL unit type octet of the SEI NAL unit). FIG. 2 illustrates the PACSI NAL unit structure containing, for example, two SEI NAL units. The values of the fields (F, NRI, Type, R, I, PRID, N, DID, QID, TID, U, D, O, RR, X, Y, A, P, C, S, E, TL0PICIDX, and IDRPICID) in the modified PACSI NAL unit shown in FIG. 2 are set in accordance with the recent SVC RTP payload format draft. It should be noted as well that the semantics of the other fields (except for the “T” bit as described below) remain unchanged (from the SVC RTP payload specification draft).

As described above, the PACSI NAL unit has been modified from that described in the SVC RTP payload specification draft. In particular, the semantics of the T bit are changed, NCSDOS, SESNUMx, and TSDIFx fields (described in greater detail below) are added, and the DONC field (that specifies the value of DON for the first NAL unit in the single-time aggregation packet type A (STAP-A) in transmission order is removed. When the T bit is equal to 0, NCSDOS, SESNUMx, and TSDIFx are not present. When the T bit is equal to 1, NCSDOS, SESNUMx, and TSDIFx are present. NCSDOS+1 indicates the number of pairs (SESNUMx, TSDIFx), also referred to as CS-DOS samples.

Using the following derivations and definitions, the semantics of SESNUMx and TSDIFx are specified. For the use of this payload specification in accordance with various embodiments, RTP sessions indicated to convey parts of the same SVC bitstream in the SDP are inferred consecutive and non-negative integer identifiers (0, 1, 2, . . . ) in the order they appear in the SDP. The current AU is the AU which the NAL unit following the PACSI NAL unit in transmission order belongs to. The x-th AU is the x-th AU following, in decoding order, the current AU.

The field SESNUMx specifies the identifier of the highest RTP session that contains NAL units for the x-th AU. The value of SESNUMx shall be in the range of 0 to 255, inclusive. The field TSDIFx is a 24-bit signed integer. TSDIFx shall be equal to RTPTS_X-RTPTS_0, where RTPTS_X and RTPTS_0 are normalized RTP timestamps with the same starting offset, infinite length (with no timestamp wrapover), and the same clock frequency and source. RTPTS_X and RTPTS_0 are the normalized RTP timestamps for the x-th AU and the current AU, respectively.

Normalized RTP timestamps can be derived with the following process. The RTP timestamp of the very first AU for the base RTP session is equal to INITTS0. It is converted to a NTP timestamp (INITNTP) through Real-time Transport Control Protocol (RTCP) sender reports for the base RTP session. INITNTP is converted to RTP timestamp INITTSx of each enhancement RTP session through their respective RTCP sender reports. The previous RTP timestamp (in output order) within an RTP session is denoted as PREVTSx and its respective normalized RTP timestamp as NPREVTSx. For the second AU across sessions, PREVTSx is equal to INITTSx and NPREVTSx is equal to INITTS0. The normalized RTP timestamp NTSx can be derived from the RTP timestamp TSx as follows for AUs other than the very first AU:

NTSx=NPREVTSx+(TSx−PREVTSx), when TSx>PREVTSx

NTSx=NPREVTSx+(2̂32−PREVTSx+TSx), when TSx<PREVTSx

It should be noted that the conversion form RTP to NTP timestamp and back to RTP timestamp may cause some rounding errors. Therefore, the RTP timestamp offsets between RTP sessions can be recorded with an AU that has NAL units present in each RTP session. Alternatively, if the sampling instants have a constant interval pattern identified by “cs-dos-sequence media parameter,” the knowledge of constant timestamp intervals between AUs can be used to record RTP timestamp offsets between RTP sessions.

With regard to media type parameters, the following optional parameters are specified in the augmented Backus-Naur form (ABNF) and documented in RFC4234 (D. Crocker (ed.), “Augmented BNF for Syntax Specifications: ABNF”, IETF RFC 4234, October 2005, available from http://www.ietf.org/rfc/rfc4234.txt):

“sprop-cs-dos-sequence:” num-samples <num-samples>cs-dos-sample
num-samples = integer
cs-dos-sample = “(“ sesnum ”, tsdif ”)”
sesnum = integer
tsdif = signed-integer
signed-integer = [“-”] integer
integer = POS-DIGIT *DIGIT
POS-DIGIT = %x31-39 ; 1 - 9

The parameter DIGIT is also specified in RFC4234. Additionally, the parameter sesnum shall be in the range of 0 to 255, inclusive. The parameter tsdif shall be in the range of −2̂23 to 2̂23-1, inclusive.

A sequence of CS-DOS samples, cs-dos-sample(i) or cs-dos-sample(sesnum(i), tsdif(i)), is provided in SDP, where i=0, 1, 2, . . . , num-samples, inclusive. The number of AUs between any two continuous AUs in decoding order for which NAL units are present in a particular RTP session (sesnum(0)) but not any higher session shall be constant. The following semantics apply for any AU (referred to as the current AU in the semantics) for which NAL units are present in RTP session sesnum(0) but not any higher session.

The parameter num-samples shall be equal to the number of AUs in all the RTP sessions from the current AU to the next AU in decoding order, inclusive, for which sesnum is equal to sesnum(0). The parameter sesnum(i) specifies the session identifier of the highest RTP session that contains at least one NAL unit of the i-th next AU in decoding order compared to the current AU. The parameter sesnum(0) indicates the RTP session number for the current AU (i.e., the first AU of the specified sequence). The parameter sesnum(num-samples −1) shall be equal to sesnum(0). The parameter sesnum(i) shall not be equal to sesnum(0) for values of i in the range of 1 to num-samples −2, inclusive. The parameter tsdif(i) specifies the difference between the normalized RTP timestamps of the i-th next AU in decoding order as compared to the current AU and the current AU. The parameter tsdif(0) shall be equal to 0.

An example of the sprop-cs-dos-sequence media parameter is given next. There are two RTP sessions in the given example, one providing the base layer at 15 frames per second and a second one enhancing the base layer temporally to 30 frames per second. No AU of one RTP session is present in the other RTP session. A 90-kHz clock is assumed, which makes a frame interval of 30 frames per second equal to 3000. Given these assumptions, the sprop-cs-dos-sequence media parameter is defined as follows: sprop-cs-dos-sequence: 3 (0, 0) (1, 3000) (0, 6000).

In accordance with various embodiments, packetization rules and de-packetization guidelines for session multiplexing are provided. It should be noted that different RTP sessions may use different packetization modes. Additionally, CS-DOS information must be complete. That is, it must be possible to derive the cross session decoding order for each NAL unit based on the CS-DOS information with the following process. When CS-DOS information is included in PACSI NAL units, it is not required to have PACSI NAL units or CS-DOS information included in each RTP packet stream.

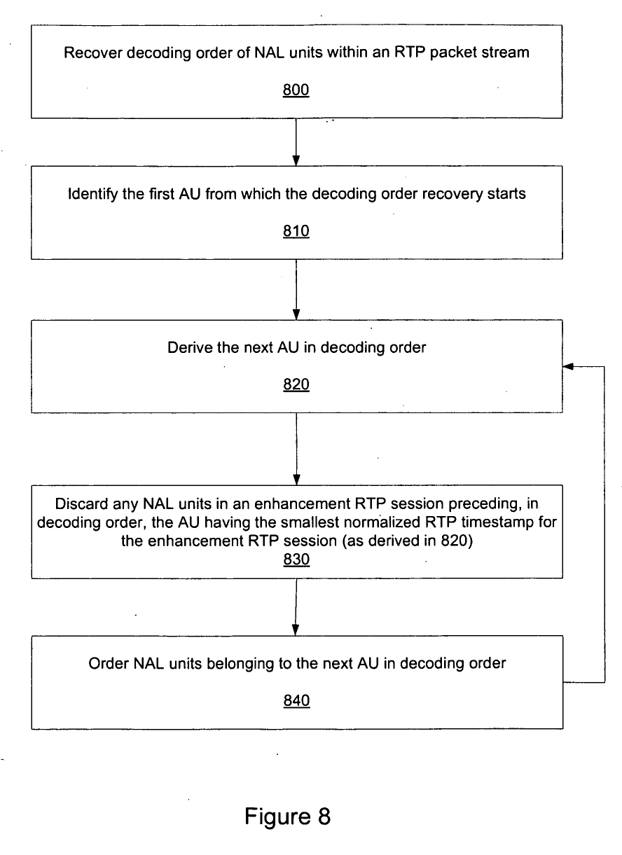

FIG. 8 is a flow chart illustrating various exemplary processes performed by a receiver in conjunction with various embodiments. In a first exemplary process in accordance with various embodiments, the decoding order of NAL units is recovered within an RTP packet stream as follows at 800. When the single NAL unit packetization mode or the non-interleaved packetization mode is in use, the decoding order of packets is recovered by arranging packets in ascending RTP header sequence number order, and taking the wrapover of sequence numbers after the maximum 16-bit unsigned integer into account. The decoding order of packets is recovered for a relatively small number of packets at a time after sufficient amount of buffering has been performed to compensate for potentially varying transmission delay of these packets. It depends on the application and network environment how much buffering is sufficient for recovery of packet decoding order with an RTP packet stream. When the non-interleaved packetization mode is in use, the decoding order of NAL units within a packet is the same as the appearance order of NAL units in the packet.

When the interleaved packetization mode is in use, the deinterleaving process is used to arrange NAL units to decoding order. The deinterleaving process is based on the DON (that is, IS-DON), which is indicated or derived for each NAL unit. NAL units are decoded in ascending order of DON, taking wrapover into account.

In a second exemplary process, the first AU from which the decoding order recovery starts is identified at 810. It is an AU associated with a PACSI NAL unit having CS-DOS information or an AU for which NAL units appear in RTP session sesnum(0) (indicated in the SDP) but not in any higher RTP session. Any NAL units preceding the first AU in decoding order (within the RTP sessions for which NAL units are present in the first AU) are discarded.

In a third exemplary process, the next AU in decoding order is derived at 820. At the beginning of the decoding order recovery process, the next AU is the first AU derived in the second process. After that, the next AU in decoding order and the highest RTP session carrying at least one NAL unit of the next AU are derived from the CS-DOS information as follows.

When CS-DOS information is conveyed in SDP, let BASETS be equal to the normalized RTP timestamp of the previous AU present in the base RTP session. The normalized RTP timestamp of the next AU in decoding order is equal to BASETS+tsdif(n).

When CS-DOS information is conveyed in PACSI NAL units, the next AU in decoding order is indicated in the PACSI NAL unit, in the same packet or a packet containing earlier NAL units in decoding order.

In a fourth exemplary process, any NAL units in an enhancement RTP session preceding, in decoding order, the AU having the smallest normalized RTP timestamp for the enhancement RTP session (as derived in the third exemplary process) are discarded at 830.

In a fifth exemplary process, NAL units belonging to the next AU are ordered in decoding order with the following ordered operations at 840. In accordance with a first operation, any AU delimiter NAL unit, sequence parameter set NAL unit, and picture parameter set NAL unit in the base RTP session preceding, in decoding order, any other type of NAL units in the base RTP session are first in cross-session decoding order (in their decoding order within the base RTP session). In accordance with a second operation, SEI NAL units in any RTP session are next in cross-session decoding order in session dependency order (the base RTP session first) as indicated by “Signaling media decoding dependency in Session Description Protocol,” T. Schierl, Fraunhofer HHI, and S. Wenger, draft ietf-mmusic-decoding-dependency-01, available from http://www.ietf.org/intemet-drafts/draft-ietf-mmusic-decoding-dependency-01.txt and referred to as [I-D.ietf-mmusic-decoding-dependency]. Within an RTP session, the decoding order of SEI NAL units is the same as recovered in the first exemplary process. In accordance with a third operation, the remaining NAL units are ordered in cross-session decoding order in session dependency order (the base RTP session first) as indicated by SDP [I-D.ietf-mmusic-decoding-dependency]. Within an RTP session, the decoding order of the remaining NAL units is the same as recovered in the first exemplary process.

After the fifth exemplary process, the processing continues with the third exemplary process when there are more AUs to be processed. Otherwise, the processing ends. The next AU handled in the fifth exemplary process is considered as the previous AU, when the processing continues with the third exemplary process.

Receivers can utilize the processes described above for decoding order recovery. However, when packet losses occur, the following reception guidelines are applicable.

The SVC standard specifies the decoding process for correct bitstreams. Hence, the decoding order recovery process can be adjusted according to the capability of the decoder to cope with packet losses. A packet loss within an RTP session can be detected based on a gap in RTP sequence numbers after decoding order recovery within the RTP session. If a decoder cannot handle packet losses, NAL units may be skipped until the next instantaneous decoding refresh (IDR) AU in the target dependency representation. If a decoder can handle packet losses and no interleaving is in use, a de-packetizer can indicate in which location of the NAL unit sequence (within the RTP session) the loss occurred. Decoding order recovery process for session multiplexing is operable as long as the number of consecutive lost AUs in decoding order (across all RTP sessions) is smaller than the number of CS-DOS samples in the SDP. If no CS-DOS samples are present in the SDP, the decoding order recovery process is operable as long as the lost packets do not contain the only pieces of CS-DOS information for any AU. Senders should therefore repeat CS-DOS information for an AU at least in two different packets and adjust the number of repetitions as a function of the expected or experienced packet loss rate. If CS-DOS information cannot be derived for some AUs, receivers should skip AUs until the earliest one of the following (in decoding order):
an AU for which all RTP sessions contain NAL units,
a PACSI NAL unit with CS-DOS information is present, or
an AU is present for RTP session sesnum(0) (indicated by SDP) but not for any higher RTP session.

As described above, other embodiments are applicable to any scalable and/or layered media for which session multiplexing can be used. Additionally, other embodiments are applicable to any communication protocol which does not inherently provide a decoding order recovery mechanism for different transport sessions (for different layers of a scalable media stream). Furthermore, other embodiments can be used when a bitstream is conveyed over a single transport session. Hence, a receiver(s) can use CS-DOS information to conclude whether or not entire AUs were lost, or whether or not all NAL units for the highest layer of an AU were lost.

In accordance with another embodiment, timestamp difference information is not transmitted within the CS-DOS information samples. Such an embodiment is applicable to scenarios when, e.g., the loss of all data for an AU within an RTP session is unlikely. Consequently, information about the highest RTP session for the next AU in decoding order is sufficient to recover decoding order across RTP sessions perfectly.

In accordance with yet another embodiment, timestamp difference information is replaced or accompanied by another piece of information identifying an AU. Such information can include, for example, a decoding order number (e.g., of the first NAL unit of the AU within the highest RTP session), a RTP sequence number (e.g., of the first NAL unit of the AU within the highest RTP session), a picture order count value, a frame_num value, a pair of idr_pic_id and frame_num values, a triplet of idr_pic_id, dependency_id and frame_num values (where idr_pic_id, dependency_id and frame_num are specified in the SVC standard), or an access unit identifier (AUID) that is a number being the same for all NAL units of an access unit, being different in consecutive access units, and conveyed e.g. in the RTP payload structure. Such identifying information can alternatively include a difference of decoding order number, RTP sequence number, picture order count, frame_num, or AUID relative to that of the current AU.

With regard to other embodiments, the highest RTP session number for subsequent AUs (SESNUMx) is not indicated. That is, the described decoding recovery need not actually depend on the availability of the SESNUMx field. The SESNUMx field can improve the capability to localize packet losses to a particular AU when (pure) temporal enhancement is provided with an enhancement RTP session. When there is a gap in sequence numbers in the enhancement RTP session and the packets prior to the gap and after the gap have a different RTP sequence number, it cannot be concluded whether the lost packet(s) contained parts of the preceding or succeeding AU or all the NAL units for an AU within the enhancement RTP session. Therefore, the SESNUMx field can be used to conclude whether or not the lost packets contained all the NAL units for an AU within the enhancement RTP session. In accordance with one embodiment, a subsequent AU within the respective RTP session for which NAL units are present but no NAL units are present in any higher RTP session is indicated. In other words, a PACSI NAL unit does not contain SESNUM fields and may contain one TSDIF field that indicates the next AU in decoding order for which the RTP session containing the PACSI NAL unit is the highest RTP session containing data for the next AU. In accordance with another embodiment, all the RTP session numbers containing NAL units for a subsequent AU are indicated. In accordance with yet another embodiment, selected RTP session numbers (e.g., the lowest RTP session number and the highest RTP session number) are indicated for a subsequent AU. These embodiments can be used to, e.g., improve the localization of a packet loss to particular AUs further by enabling the ability to conclude whether or not all NAL units were lost for an AU within the indicated RTP session.

In various embodiments, the highest or lowest RTP session number or all or selected RTP session numbers containing NAL units for the current AUs are indicated. Such pieces of information can be used to conclude whether the reception of the current AU is complete. Additionally, such pieces of information can be provided in addition to or instead of any of the afore-mentioned pieces of CS-DOS information.

In accordance with another embodiment, the CS-DOS information is provided for preceding AUs in addition to or instead of the succeeding and current AU. This particular embodiment is described using two fields, AU identifier (AUID) and previous AU ID (PAUID), which are used for the recovery of the decoding order of NAL units in session multiplexing for non-interleaved transmission. It should be noted that the instead of or in addition to AUID and PAUID other means for identifying an access unit can be used with this embodiment. AUID and PAUID are conveyed in PACSI NAL units or in Fragmentation Unit Type B (FU-B) NAL units. AUID and PAUID are conveyed in at least one PACSI NAL unit or FU-B NAL unit for each access unit in each session.

It should be noted that an AUID is defined as a field or a variable that is provided or derived for each access unit when a single NAL unit packetization mode or a non-interleaved packetization mode is in use in session multiplexing. The value of an AUID is identical for all NAL units of an access unit regardless of the session which NAL units are conveyed in. The AUID values of consecutive access units differ regardless of which sessions are decoded, but there are no other constraints for AUID values of consecutive access units, i.e., the difference between AUID values of consecutive access units can be any non-zero signed integer. A PAUID indicates the AU identifier of a previous AU in decoding order among the sessions containing the packet including the PAUID field and the sessions below it in the session dependency hierarchy.

When fragmentation units are used in session multiplexing, NAL unit type FU-B is used in enhancement sessions for the first fragmentation unit of a fragmented NAL unit. The DON field of the FU-B header in enhancement sessions is replaced by the AUID field followed by the PAUID field. The value of the AUID field is equal to the AUID value for the access unit containing the fragmented NAL unit. Alternatively to using NAL unit type FU-B for the first fragmentation unit of a fragmented NAL unit, an FU-A packet can be used when it is preceded by a single NAL unit packet containing a PACSI NAL unit including the AUID and PAUID values for the fragmented NAL unit.

When a PACSI NAL unit is used in session multiplexing, the DONC field of the PACSI NAL unit syntax presented in http://www.ietf.org/internet-drafts/draft-ietf-avt-rtp-svc-10.txt is replaced by the AUID field followed by the PAUID field. When present in a PACSI NAL unit, the AUID field is indicative of the AU identifier for all of the NAL units in an aggregation packet (when the PACSI NAL unit is included in an aggregation packet) or the AUID of the next non-PACSI NAL unit in transmission order (when the PACSI NAL unit is included in a single NAL unit packet).

The decoding order recovery based on AUID and PAUID is described next and illustrated in Figure QQQ. At QQQ00, The decoding order recovery is started from an AU where NAL units are present for the base session, herein referred to as AU F. Any packets preceding the first received packet of AU F in reception order (that is, RTP sequence number order within each session) are discarded (QQQ10). The decoding order of NAL units of AU F is specified below.

For subsequent AUs to be ordered, the following applies. First, the candidate AUs that could be next in decoding order are identified in QQQ30. Let AUID(n) and PAUID(n) be the AUID and PAUID values, respectively, of the first access unit in decoding order containing data in session n. The first access unit in decoding order containing data in session n can be identified by the smallest value of RTP sequence number within session n (taking into account the potential wraparound of RTP sequence numbers) among those packets whose payloads have not been passed to the decoder yet. Let a set of sessions S consist of those values of n for which NAL units are present in the first access unit in decoding order containing data in session n but are not present in a higher session in the same AU. In other words, the set of sessions S contains the highest session of those access units that are candidates of being next in decoding order.

After selecting the candidate AUs that could be next in decoding order (which are represented by the set of sessions S), the AU that is next in decoding order is determined in QQQ40. The next AU in decoding order is the AU with the greatest value of m, where PAUID(m) is not equal to AUID(i), where m is any value within the set of sessions S and i is any value less than m within the set of sessions S. In other words, the next AU in decoding order is found by investigating the candidate AUs in session depedency order from the highest session to the lowest session according to the highest session for which the candidate AUs contain NAL units. The next AU in decoding order is the first AU in the above investigation order that is not indicated to follow any candidate AU in a lower session in decoding order. The decoding order of NAL units of the access unit having AUID equal to AUID(m) is specified below. It should be noted that the set of sessions S can be formed by considering only those AUs that have arrived within a certain inter-session jitter compensation period. Consequently, it may not be necessary to wait for all of the AUs from all sessions to arrive at a particular time for decoding order recovery.

It is noted that the procedure described above can be applied to any number of sessions in session dependency order starting from the base session. In other words, a receiver need not receive all the transmitted sessions but it can as well receive or process a subset of the transmitted sessions. If the receiver would like to change the number of received or processed sessions, the decoding order recovery for the new number of sessions can be started from an AU where NAL units are present for the base session.

If several NAL units share the same value of AUID, the order in which NAL units are passed to the decoder is specified in QQQ20 as follows: All NAL units NU(y) associated with the same value of AUID are collected. Then, the collected NAL units are placed in the session dependency order and then in the consecutive order of appearance within each session into an AU while satisfying the NAL unit order rules in SVC. Another, equivalent way to specify the order in which NAL units of an access unit are passed to the decoder is as follows. An initial NAL unit order for an access unit is formed starting from the base session and proceeding to the highest session in the session dependency order specified according to [I-D.ietf-mmusic-decoding-dependency]. Within a session, NAL units sharing the same value of AU-ID are ordered into the initial NAL unit order for the access unit in their transmission order. A NAL unit decoding order for the access unit is derived from the initial NAL unit order for the access unit by reordering SEI NAL units conveyed in a non-base session and not included PACSI NAL units as specified for the NAL unit decoding order in the SVC standard. NAL units are passed to the decoder in the NAL unit decoding order for the access unit.

Packet losses can be detected from gaps in RTP sequence numbers as with any RTP session. A loss of an entire AU can be often detected by a PAUID value that refers to an AUID that has not been received (within a reasonable period of time, before the reception of the packet conveying the PAUID value). AU losses in the highest session do not affect the capability of ordering the received AUs correctly in decoding order. Thus, if a packet loss happened in the highest session, decoding can usually continue without skipping any received access units. If an AU loss happened in session k where k is not the highest session, decoding order recovery is guaranteed to operate correctly for sessions up to k, inclusive. A receiver should not pass any NAL units for sessions above k to the decoder after an AU loss in session k and should indicate to the decoder about the AU loss. Alternatively, a receiver continues to arrange AUs in all sessions to decoding order using the algorithm above but indicates to the decoder about the AU loss and the possibility that AUs above session k may not be correctly ordered. The decoding order for AUs of all the sessions can be recovered again starting from the first following AU containing data in the base session.

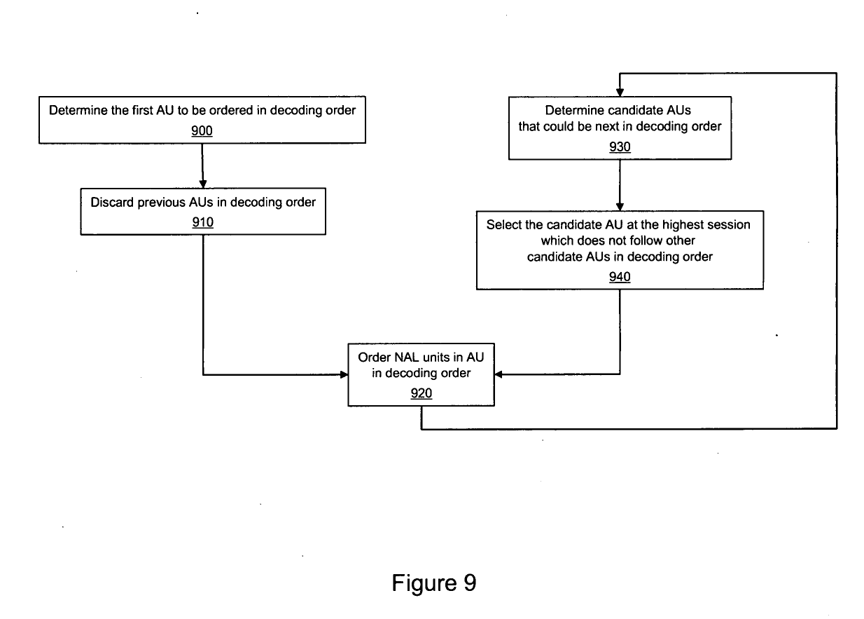

FIG. 9 illustrates an exemplary session multiplexing scenario referring to three RTP sessions, A, B and C, containing a multiplexed SVC bitstream. Session A can be a base RTP session, session B is the first enhancement RTP session and depends on session A, while session C is the second RTP enhancement session and depends on sessions A and B. In this example, session A has the lowest frame rate and session B and C have the same frame rate that is higher (using a hierarchical prediction structure) than that of session A. It should be noted that arbitrary values of AUID have been used in the example, and other AUID values are contemplated by various embodiments. It should further be noted that decoding order runs from left to right, and the values in ‘( )’ refer to AUID and PAUID values, e.g., ‘(AUID, PAUID)’, where a may be an arbitrary value as already described. The ‘|’ in FIG. 9 indicates the corresponding NAL units of the AU(TS[..]) in the RTP sessions. If ‘|’ is open-ended, i.e., does not point to a pair of values in ‘( )’, the respective NAL units have not been received e.g. during a startup period due to inter-session differences in end-to-end delay. The integer values in ‘[ ]’ refer to a media Timestamp (TS), sampling time as derived from RTP timestamps associated with the AU(TS[..]).

More particularly, FIG. 9 is illustrative of exemplary de-jitter buffering with different jitters present in the sessions. That is, at buffering startup, not all packets with the same timestamp (TS) are available in all of the de-jittering buffers. Jitter between the sessions is first assumed to be compensated by removing all NAL units preceding NAL unit with an AUID that is equal to 2 (TS[1]).

Furthermore, the first AU with data present in the base session is identified. In this example illustrated in FIG. 9, it is the AU with an AUID equal to 4 (TS[8]). The preceding AUs (with an AUID equal to 2 (TS[1]) and an AUID equal to 5 (TS[3])) are removed. NAL units of an AU with an AUID equal to 4 (TS[8]) are passed to the decoder in layer dependency order. The next AU (with an AUID equal to 6 (TS[6])) has NAL units present in each session, and thus it is selected as the next AU to be decoded.

Within independent sessions, the next NAL units in decoding order belong to the AU with an AUID equal to 8 (TS[5]) (in sessions B and C) and to the AU with an AUID equal to 9 (TS[12]) (in session A). Because session B and session A are not the highest sessions for the AU with an AUID equal to 8 and 9, respectively, the set of sessions S consists of only one session and the AU with an AUID equal to AUID(C) is selected as the next AU in decoding order. The decoding order recovery process is then continued similarly for subsequent AUs, i.e., at any stage, there is only one session in the set of sessions S that corresponds to the next AU in decoding order.

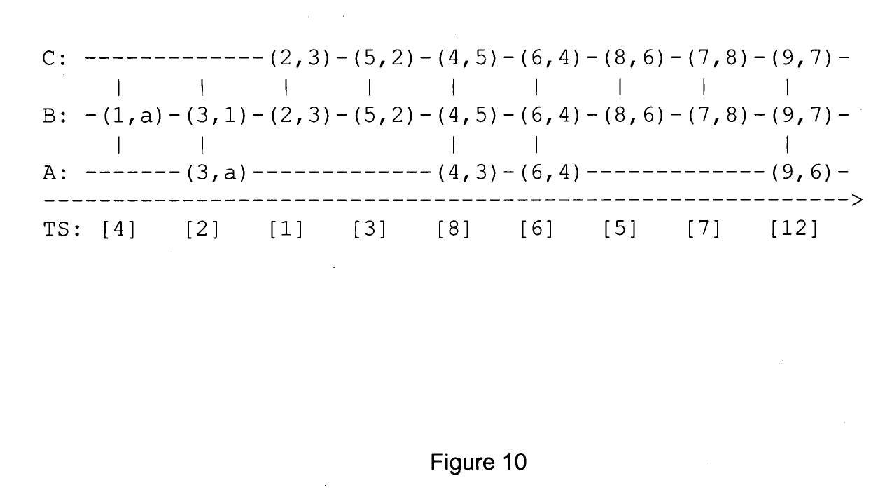

FIG. 10 is an illustration of another exemplary session multiplexing scenario, where three RTP sessions, A, B, and C, contain a multiplexed SVC bitstream. Session A is the base RTP session, B is the first enhancement RTP session and depends on session A, and session C is the second RTP enhancement session and depends on sessions A and B. Sessions A, B, and C represent different levels of temporal scalability. It should be noted that arbitrary AUID values have been used in the example, and other AUID values are contemplated by various embodiments. The initial de-jittering is not illustrated in FIG. 10 but is assumed to be handled similarly to that described above in the exemplary scenario illustrated in FIG. 9.

A first AU with data present in the base session is identified. In this example, it is the AU with an AUID equal to 3 (TS[8]). The preceding AU (where AUID equal to 2 (TS[3]) is removed. The next NAL units in decoding order belong to the AU with an AUID equal to 9, 5, and 1 for sessions A, B, and C, respectively. Therefore, AUID(A)=9, PAUID(A)=3, AUID(B)=5, PAUID(B)=3, AUID(C)=1, and PAUID(C)=5. All three sessions A, B, and C are present in a set of sessions S. Because PAUID(C) is equal to AUID(B), the AU with an AUID equal to AUID(C) is not selected as the next AU in decoding order. Because PAUID(B) is not equal to AUID(A), the AU with an AUID equal to AUID(B) is selected as the next AU in decoding order.

The next NAL units in decoding order belong to the AU with an AUID equal to 9, 8, and 1 for sessions A, B, and C respectively, and therefore, AUID(A)=9, PAUID(A)=3, AUID(B)=8, PAUID(B)=9, AUID(C)=1, and PAUID(C)=5. All three sessions A, B, and C, are present in the set of sessions S. As PAUID(C) is not equal to AUID(B) or AUID(A), the AU with an AUID equal to AUID(C) is selected as the next AU in decoding order. After that, the AU with an AUID equal to 4 is selected similarly as the next in decoding order.

The next NAL units in decoding order belong to the AU with an AUID equal to 9, 8, and 7 for sessions A, B, and C respectively, and thus AUID(A)=9, PAUID(A)=3, AUID(B)=8, PAUID(B)=9, AUID(C)=7, and PAUID(C)=8. All three sessions A, B, and C are present in the set of sessions S. Because PAUID(C) is equal to AUID(B) and PAUID(B) is equal to AUID(A), the A with an AUID equal to AUID(C) or AUID(B) is not selected as the next AU in decoding order. As there is no session below session A, the AU with an AUID equal to AUID(A) is selected as the next AU in decoding order. The decoding order recovery process is then continued similarly for subsequent AUs.

With yet another embodiment, another type of RTP session identifier is used, such as the value of the “mid” attribute of SDP specified in RFC3388. Alternatively still, the transmitted RTP packet streams also comply with the requirements of the classical RTP decoding order recovery mode in order to allow its usage in receivers. Hence, receivers can improve the handling of packet losses.

In accordance with still another alternative embodiment, CS-DOS information is provided in the RTP header extension. The transmitted RTP packet streams comply with the requirements of the classical RTP decoding order recovery mode in order to allow its usage in receivers, as the use of RTP header extensions is optional for receivers. Hence, as described above, when the classical RTP decoding order recovery mode is used, receivers can improve the handling of packet losses. Alternatively, still another protocol may be used to convey session parameters instead of SDP.

In accordance with yet another alternative embodiment, CS-DOS information can be additionally provided in NAL units inserted in an RTP stream e.g. to avoid non-AU-aligned NAL units. These NAL units inserted in an RTP stream can be e.g. PACSI NAL units where the semantics of those fields conventionally describing the contents of the associated packet are re-specified. However, the CS-DOS information in a PACSI NAL unit inserted to avoid non-AU-aligned NAL units can remain unchanged.

Various embodiments described herein provide systems and methods of decoding order recovery such that senders do not have to include additional NAL units (e.g. NAL units specified by the SVC specification) into the transmitted stream and receivers do not have to remove these additional NAL units. Additionally, packet loss robustness is improved. That is, conventionally, a smaller amount of NAL units (if any) have to be skipped to resynchronize the decoding order recovery process. Hence, the amount of skipped NAL units never exceeds that required by the classical RTP decoding order recovery mode. Furthermore, when frame rates in all RTP sessions are stable, no additional data within any RTP session is required but rather everything can be signaled with SDP.

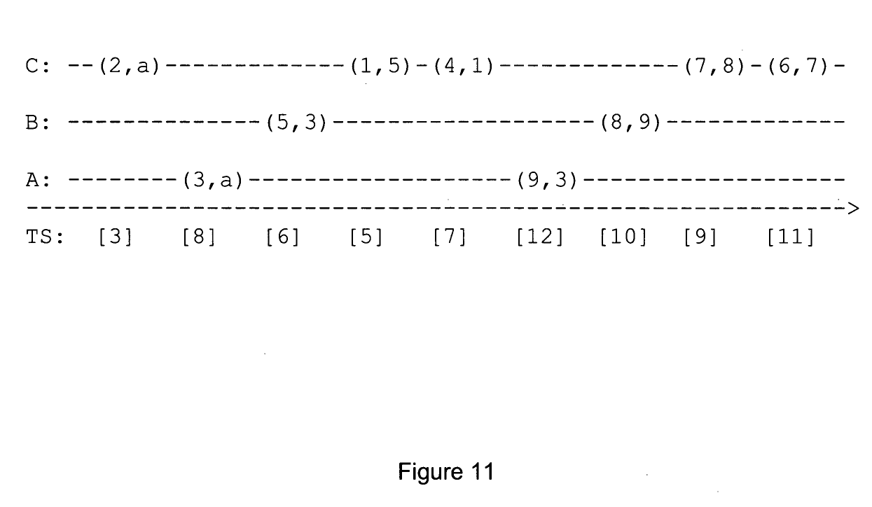

FIG. 11 is a flow chart illustrating various processes performed in accordance with various embodiments described herein. More or less processes may be performed in accordance with various embodiments. From, e.g., a packetizing/encoding perspective, FIG. 11 shows a method of packetizing a media stream into transport/transmission packets. At 1100, it is determined whether application data units are to be conveyed in a first transmission session and a second transmission session. At 1110, upon a determination that the application data units are to be conveyed in the first transmission session and the second transmission session, at least a part of a first media sample in a first packet and at least a part of a second media sample in a second packet are packetized. The first media sample and the second media sample have a determined decoding order. Additionally at 1120, signaling first information to identify the second media sample is performed, where the first information is associated with the first media sample. The first information can be, e.g., a first interval between the first and second media samples.

As described above, the first interval can be, e.g., a RTP timestamp difference between the first and second media samples. Additionally, the signaling can comprise encapsulating the first interval in the first packet, encapsulating the first interval in a packet preceding the first packet, or encapsulating the first interval in session parameters. Moreover, the transmission session that carries the second packet is also signaled in accordance with various embodiments. For example, the second packet may be transmitted in the second transmission session, where the first information is an identifier of the second transmission session.

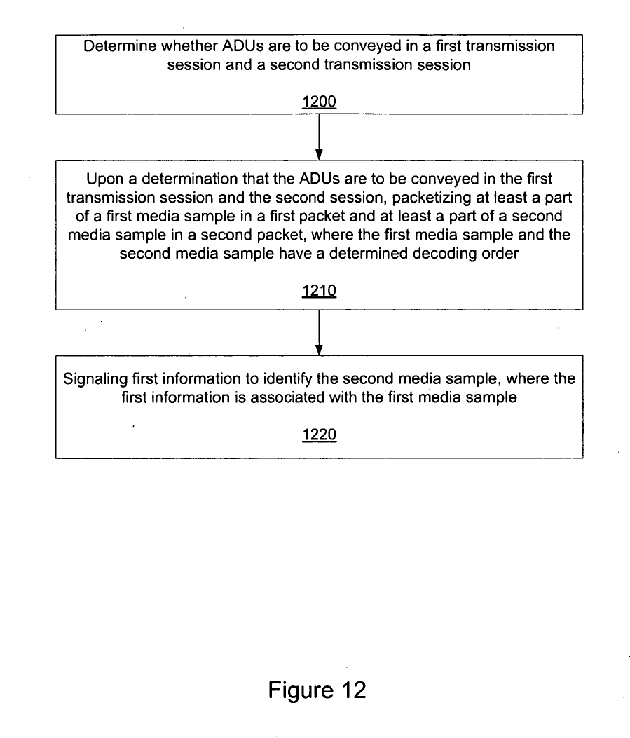

FIG. 12 is a flow chart illustrating various processes performed in accordance with various embodiments herein from, e.g., a de-packetizing/decoding perspective. That is, FIG. 12 shows processes performed for, e.g., de-packetizing transport packets of a first transmission session and a second transmission session into a media stream, where media data included in the first transmission session is required to decode media data included in the second transmission session. At 1200, a first packet is de-packetized, where the first packet includes at least a part of a first media sample, and a second packet including at least a part of a second media sample is also de-packetized. At 1210, a decoding order of the first media sample and the second media sample is determined based on received signaling of first information to identify the second media sample, where the first information is associated with the first media sample. For example, the first information can be an interval between the first media sample and the second media sample. It should be noted that more or less processes may be performed in accordance with various embodiments.

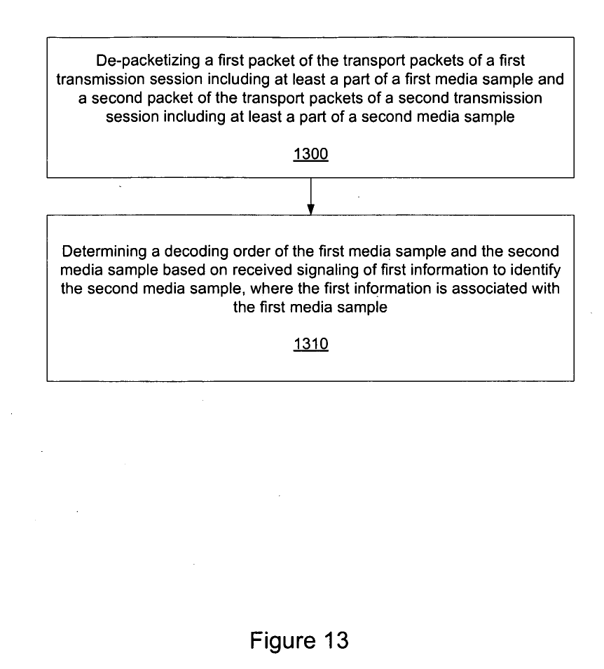

FIG. 13 is a graphical representation of a generic multimedia communication system within which various embodiments may be implemented. As shown in FIG. 13, a data source 1300 provides a source signal in an analog, uncompressed digital, or compressed digital format, or any combination of these formats. An encoder 1310 encodes the source signal into a coded media bitstream. It should be noted that a bitstream to be decoded can be received directly or indirectly from a remote device located within virtually any type of network. Additionally, the bitstream can be received from local hardware or software. The encoder 1310 may be capable of encoding more than one media type, such as audio and video, or more than one encoder 1310 may be required to code different media types of the source signal. The encoder 1310 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 13 only one encoder 1310 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 1320. The storage 1120 may comprise any type of mass memory to store the coded media bitstream. The format of the coded media bitstream in the storage 1320 may be an elementary self-contained bitstream format, or one or more coded media bitstreams may be encapsulated into a container file. When a container file is generated, there can be an additional actor, referred to as server file generator 1315, between the encoder 1310 and storage 1320. Alternatively, the functions performed by the server file generator 1315 may be attached to the encoder 1310. The server file generator 1315 may include packetization instructions into the file, indicating one or more preferred encapsulation procedures how the bitstream can be packetized for transmission. The container file may comply with the ISO Base Media File Format (ISO/IEC International Standard 14496-12) and the packetization instructions may be provided in accordance with the hint track feature of the ISO Base Media File Format. If packetization instructions are created for a layered and/or scalable bitstream and session multiplexing, the server file generator 1315 can apply various embodiments of the invention. Some systems operate “live”, i.e. omit storage and transfer coded media bitstream from the encoder 1310 directly to the sender 1330. The coded media bitstream is then transferred to the sender 1330, also referred to as the server, on a need basis. The format used in the transmission may be an elementary self-contained bitstream format, a packet stream format, or one or more coded media bitstreams may be encapsulated into a container file. The encoder 1310, the server file generator 1315, the storage 1320, and the server 1330 may reside in the same physical device or they may be included in separate devices. The encoder 1310 and server 1330 may operate with live real-time content, in which case the coded media bitstream is typically not stored permanently, but rather buffered for small periods of time in the content encoder 1310 and/or in the server 1330 to smooth out variations in processing delay, transfer delay, and coded media bitrate.

The server 1330 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the server 1330 encapsulates the coded media bitstream into packets. For example, when RTP is used, the server 1330 encapsulates the coded media bitstream into RTP packets according to an RTP payload format. Typically, each media type has a dedicated RTP payload format. It should be again noted that a system may contain more than one server 1330, but for the sake of simplicity, the following description only considers one server 1330. If layered and/or scalable bitstream is sent and session multiplexing is used, the server 1330 can apply various embodiments of the invention.

The server 1330 may or may not be connected to a gateway 1340 through a communication network. The gateway 1340 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 1340 include MCUs, gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 1340 is called an RTP mixer or an RTP translator and typically acts as an endpoint of an RTP connection.

The system includes one or more receivers 1350, typically capable of receiving, de-modulating, and de-capsulating the transmitted signal into a coded media bitstream. The coded media bitstream is transferred to a recording storage 1355. The recording storage 1355 may comprise any type of mass memory to store the coded media bitstream. The recording storage 1355 may alternatively or additively comprise computation memory, such as random access memory. The format of the coded media bitstream in the recording storage 1355 may be an elementary self-contained bitstream format, or one or more coded media bitstreams may be encapsulated into a container file. If there are multiple coded media bitstreams, such as an audio stream and a video stream, associated with each other, a container file is typically used and the receiver 1350 comprises or is attached to a container file generator producing a container file from input streams. The receiver 1350 or the container file generator may perform de-capsulation from a received packet stream to a bitstream. If layered and/or scalable media is transmitted and session multiplexing is used, the receiver or the container file generator should additionally perform decoding order recovery, for which one of the embodiments of the invention can be applied. Alternatively, the receiver 1350 or the container file generator can store received packet streams or instructions how to reconstruct received packet streams. The container file may comply with the ISO Base Media File Format (ISO/IEC International Standard 14496-12) or the DVB file format. Received packet streams or instructions regarding how to reconstruct received packet streams may be provided in accordance with the reception hint track feature of the Technologies under Consideration for the ISO Base Media File Format (ISO/IEC MPEG document N9680) or the draft DVB File Format (DVB document TM-FF0020r8). A container file including received packet streams or instructions how to reconstruct received packet streams may be later processed to include media bitstreams by a file converter (not shown in the figure). If layered and/or scalable media was transmitted and session multiplexing was used for the stored packet streams or for the packet streams for which instructions to reconstruct them are stored, the file converter may perform decoding order recovery using one of the embodiments of the invention. Some systems operate “live,” i.e. omit the recording storage 1355 and transfer coded media bitstream from the receiver 1350 directly to the decoder 1360. In some systems, only the most recent part of the recorded stream, e.g., the most recent 10-minute excerption of the recorded stream, is maintained in the recording storage 1355, while any earlier recorded data is discarded from the recording storage 1355.

The coded media bitstream is transferred from the recording storage 1355 to the decoder 11360. If there are many coded media bitstreams, such as an audio stream and a video stream, associated with each other and encapsulated into a container file, a file parser (not shown in the figure) is used to decapsulate each coded media bitstream from the container file. The recording storage 1355 or a decoder 1360 may comprise the file parser, or the file parser is attached to either recording storage 1355 or the decoder 1360. If decoding order recovery is not done in any of the earlier functional blocks, the file parser or the decoder 1360 may perform it using one of the embodiments of the invention.

The coded media bitstream is typically processed further by a decoder 1360, whose output is one or more uncompressed media streams. Finally, a renderer 1370 may reproduce the uncompressed media streams with a loudspeaker or a display, for example. The receiver 1350, recording storage 1355, decoder 1360, and renderer 1370 may reside in the same physical device or they may be included in separate devices.

A sender 1330 according to various embodiments may be configured to select the transmitted layers for multiple reasons, such as to respond to requests of the receiver 1350 or prevailing conditions of the network over which the bitstream is conveyed. A request from the receiver can be, e.g., a request for a change of layers for display or a change of a rendering device having different capabilities compared to the previous one.

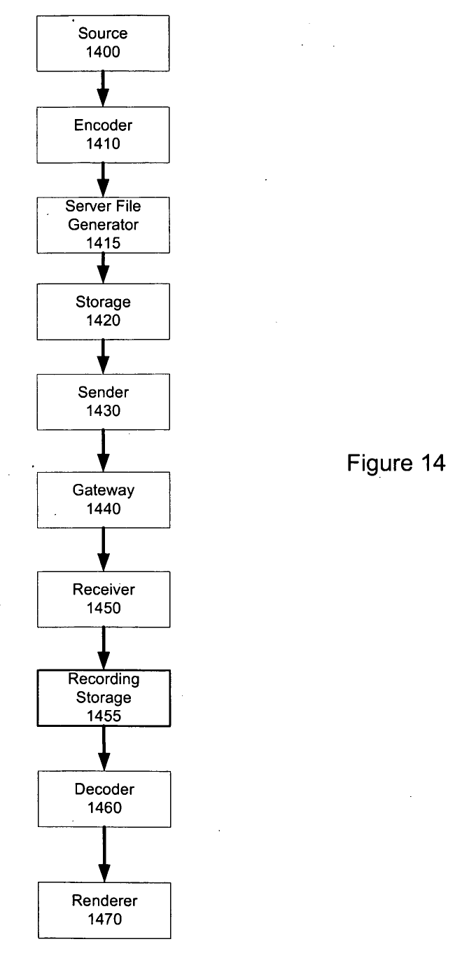

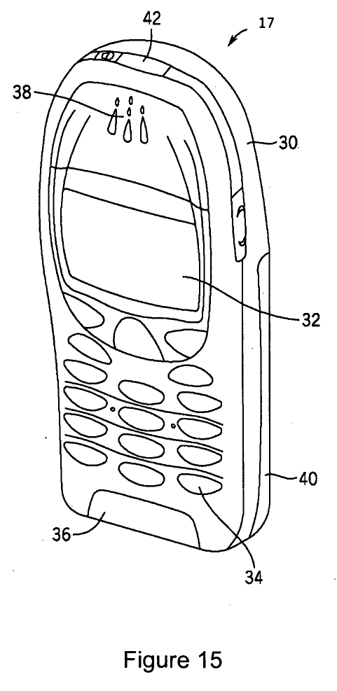

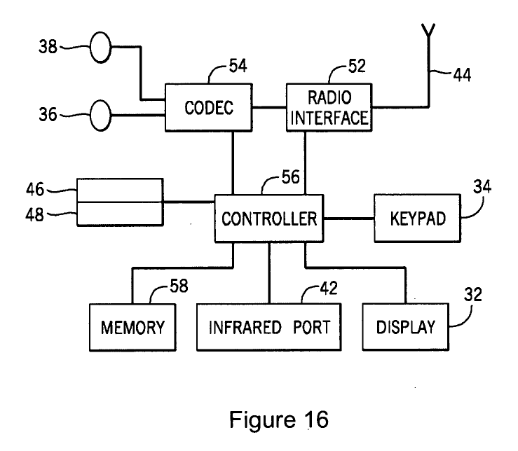

FIGS. 14 and 15 show one representative electronic device 14 within which the present invention may be implemented. It should be understood, however, that the present invention is not intended to be limited to one particular type of device. The electronic device 14 of FIGS. 14 and 15 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method of packetizing a media stream into transport packets, the method comprising:
determining whether application data units are to be conveyed in a first transmission session and a second transmission session;
upon a determination that the application data units are to be conveyed in the first transmission session and the second transmission session, packetizing at least a part of a first media sample in a first packet and at least a part of a second media sample in a second packet, the first media sample and the second media sample having a determined decoding order; and
signaling first information to identify the second media sample, the first information being associated with the first media sample.

2. The method of claim 1, wherein the second media sample is associated with a sample identifier and the first information is the sample identifier.

3. The method of claim 1, wherein the first information is a first interval between the first media sample and the second media sample.

4. The method of claim 3, wherein the first interval is a presentation time difference between the first media sample and the second media sample.

5. The method of claim 3, wherein the first interval is a Real-time Transport Protocol Timestamp difference between the first media sample and the second media sample.

6. The method of claim 1, wherein the second packet is transmitted in the second transmission session and the first information is an identifier of the second transmission session.

7. A computer program product, embodied on a computer-readable medium, comprising computer code configured to perform the process of claim 1.

8. An apparatus, comprising:
a processor; and
a memory unit communicatively connected to the processor wherein the apparatus is configured to:
determine whether application data units are to be conveyed in a first transmission session and a second transmission session;
upon a determination that the application data units are to be conveyed in the first transmission session and the second transmission session, packetize at least a part of a first media sample in a first packet and at least a part of a second media sample in a second packet, the first media sample and the second media sample having a determined decoding order; and
signal information to identify the second media sample, the first information being associated with the first media sample.

9. The apparatus of claim 8, wherein the second media sample is associated with a sample identifier and the first information is the sample identifier.

10. The apparatus of claim 8, wherein the first information is a first interval between the first media sample and the second media sample.

11. The apparatus of claim 10, wherein the first interval is a presentation time difference between the first media sample and the second media sample.

12. The apparatus of claim 10, wherein the first interval is a Real-time Transport Protocol Timestamp difference between the first media sample and the second media sample.

13. The apparatus of claim 8, wherein the apparatus being further configured to transmit the second packet in the second transmission session and the first information is an identifier of the second transmission session.

14. An apparatus, comprising:
means for determining whether application data units are to be conveyed in a first transmission session and a second transmission session;
means for, upon a determination that the application data units are to be conveyed in the first transmission session and the second transmission session, packetizing at least a part of a first media sample in a first packet and at least a part of a second media sample in a second packet, the first media sample and the second media sample having a determined decoding order; and
means for signaling first information to identify the second media sample, the first information being associated with the first media sample.

15. The apparatus of claim 14, wherein the second media sample is associated with a sample identifier and the first information is the sample identifier.

16. The apparatus of claim 14, wherein the first information is a first interval between the first media sample and the second media sample.

17. A method of de-packetizing transport packets, the method comprising:
de-packetizing a first packet of the transport packets of a first transmission session including at least a part of a first media sample and a second packet of the transport packets of a second transmission session including at least a part of a second media sample; and
determining a decoding order of the first media sample and the second media sample based on received signaling of first information to identify the second media sample, the first information being associated with the first media sample.

18. The method of claim 17, wherein the second media sample is associated with a sample identifier and the first information is the sample identifier.

19. The method of claim 18, wherein the sample identifier is indicative of a preceding media sample in decoding order among at least the first and second transmission sessions, and wherein one of the at least first and second transmission sessions comprises a base session and the other of the at least first and second transmission sessions comprises an enhancement session.

20. The method of claim 17, wherein the first information is a first interval between the first media sample and the second media sample.

21. The method of claim 20, wherein the first interval is a presentation time difference between the first media sample and the second media sample.

22. The method of claim 20, wherein the first interval is a Real-time Transport Protocol Timestamp difference between the first media sample and the second media sample.

23. A computer program product, embodied on a computer-readable medium, comprising computer code configured to perform the process of claim 17.

24. An apparatus, comprising:
a processor; and
a memory unit communicatively connected to the processor wherein the apparatus is configured to:
de-packetize a first packet of the transport packets of a first transmission session including at least a part of a first media sample and a second packet of the transport packets of a second transmission session including at least a part of a second media sample; and
determine a decoding order of the first media sample and the second media sample based on received signaling of first information to identify the second media sample, the first information being associated with the first media sample.

25. The apparatus of claim 24, wherein the second media sample is associated with a sample identifier and the first information is the sample identifier.

26. The apparatus of claim 25, wherein the sample identifier is indicative of a preceding media sample in decoding order among at least the first and second transmission sessions, and wherein one of the at least first and second transmission sessions comprises a base session and the other of the at least first and second transmission sessions comprises an enhancement session.

27. The apparatus of claim 24, wherein the first information is a first interval between the first media sample and the second media sample.

28. The apparatus of claim 27, wherein the first interval is a presentation time difference between the first media sample and the second media sample.

29. The apparatus of claim 27, wherein the first interval is a Real-time Transport Protocol Timestamp difference between the first media sample and the second media sample.

30. An apparatus, comprising:
means for de-packetizing a first packet of the transport packets of a first transmission session including at least a part of a first media sample and a second packet of the transport packets of a second transmission session including at least a part of a second media sample; and
means for determining a decoding order of the first media sample and the second media sample based on received signaling of first information to identify the second media sample, the first information being associated with the first media sample.

31. The apparatus of claim 30, wherein the second media sample is associated with a sample identifier and the first information is the sample identifier.

32. The apparatus of claim 30, wherein the first information is a first interval between the first media sample and the second media sample.
